(19) United States
(12) Patent Application Publication
(10) Pub. No.: US 2026/0201530 A1
(43) Pub. Date: Jul. 16, 2026

(54) NB55TI PLATE FOR A SUPERCONDUCTING RADIO-FREQUENCY CAVITY AND PREPARATION METHOD THEREOF

(71) Applicant: Northwest Institute For Non-ferrous Metal Research, Xi'an (CN)

(72) Inventors: Jiapeng Cheng, Xi'an (CN); Nianhua Xiong, Xi'an (CN); Xinlin Li, Xi'an (CN); Ting Gao, Xi'an (CN); Jiayuan Zhao, Xi'an (CN); Junshuai Ren, Xi'an (CN)

(21) Appl. No.: 19/433,990

(22) Filed: Dec. 29, 2025

(30) Foreign Application Priority Data
Jan. 15, 2025 (CN) 202510061069.3

(51) Int. Cl. C22F 1/18; B21J 5/08; C22F 1/02; H05H 7/20

(52) U.S. Cl. CPC C22F 1/183; B21J 5/08; C22F 1/02; H05H 7/20

(57) ABSTRACT

A Nb55Ti plate for a superconducting radio-frequency cavity and a preparation method thereof are provided, which relates to the technical field of superconducting acceleration cavities. The method includes: forging, processing of a surface of a slab blank, rolling, processing of a surface of a plate blank, heat treatment of a processed plate blank, and processing of a heat-treated plate blank. By a rational design of processing procedures and limits of process parameters, and combined with vacuum heat treatment and surface processing, the method effectively breaks and refines initial microstructure of a Nb55Ti blank, significantly improves uniformity of grain size, uniformity of transverse and longitudinal structure, and properties of the Nb55Ti plate, and enhances hardness of the Nb55Ti plate, which is suitable for superconducting radio-frequency cavities. Moreover, the method increases processing yield of the Nb55Ti plate, reduces raw material costs, and enables stable mass production.

### CROSS-REFERENCE TO RELATED APPLICATION

This application claims priority to Chinese patent application No. CN202510061069.3, filed to China National Intellectual Property Administration (CNIPA) on Jan. 15, 2025, which is herein incorporated by reference in its entirety.

### TECHNICAL FIELD

The disclosure relates to the technical field of superconducting acceleration cavities, and in particular to a Nb55Ti plate for a superconducting radio-frequency cavity and a preparation method thereof.

### BACKGROUND

Superconducting radio frequency accelerators are a type of radio frequency field accelerators, which are devices that employ a radio frequency electromagnetic field in an acceleration cavity to accelerate charged particles. A 1.3 megahertz (GHz) 9-cell radio frequency acceleration chamber is mainly composed of a high-purity niobium chamber and a titanium jacket. A Nb55Ti plate is a transitional connection between the niobium chamber and the titanium jacket, which is respectively welded to the niobium chamber and the titanium jacket. The Nb55Ti plate plays a role of locating the chamber in the accelerator.

A Nb55Ti alloy possesses characteristics of high strength, low elastic modulus, good thermal conductivity, excellent plasticity, good cold formability, and good corrosion resistance, which demonstrates excellent comprehensive performance in fields of aviation, aerospace, chemical engineering, and superconductivity. The Nb55Ti alloy is used as a superconducting material in nuclear magnetic resonance imaging (MRI), high-energy physics accelerators in strong electromagnetic fields, plasma magnetic confinement devices, and superconducting energy storage devices. Due to good welding performance with titanium and niobium, the Nb55Ti alloy has also been widely used as a connector for titanium and niobium alloy materials in recent years.

In recent years, with rapid development of superconducting radio frequency technologies, structural designs of superconducting acceleration cavities become increasingly complex, and have new requirements for strength of cavity structures with high requirements for mechanical properties and microstructure of Nb55Ti alloy plates. However, existing researches in the related art in China have not paid attention to the mechanical properties and microstructure of Nb55Ti. For current new structures of the superconducting cavities, a key to processing Nb55Ti plates is to control uniformity of the material properties and microstructure.

### SUMMARY

To solve the above technical problems, the disclosure provides a Nb55Ti plate for a superconducting radio-frequency cavity and preparation method thereof.

To achieve the above technical solutions, the disclosure provides a preparation method for a Nb55Ti plate for a superconducting radio-frequency cavity, including the following steps S1-S6:
S1, forging, including: heating a niobium-titanium alloy ingot with a size of Φ×L, a mass fraction of niobium (Nb) of 44% to 46%, and a mass fraction of titanium (Ti) of 54% to 56% to a temperature of 850 Celsius degrees (° C.) to 900° C., followed by holding the niobium-titanium alloy ingot at 850° C. to 900° C. for (0.5 to 0.6)×Φ minutes (min) to obtain a heated ingot; performing blooming forging on the heated ingot to obtain a slab blank with a size of H1×B1×L1;
S2, processing a surface of the slab blank, including: machining the slab blank obtained from step S1 with a computer numerical control (CNC) milling machine to remove surface defects of the slab blank to obtain a machined slab blank;
S3, rolling, including: rolling the machined slab blank in step S2 to obtain a plate blank with a size of H3×B2×L2; where, during the rolling, a heating temperature is in a range of 800° C. to 850° C., and a heating holding time is (0.8 to 1)× H1 min;
S4, processing a surface of the plate blank, including: sanding the plate blank obtained from step S3 with a sander to obtain a sanded plate blank, placing the sanded plate blank in an acid solution to perform acid pickling for 3 min to 5 min, followed by rinsing with clean water and natural air drying to obtain a processed plate blank, to ensure that a surface roughness Ra of the processed plate blank is smaller than or equal to 1.6 microns (μm);
S5, performing heat treatment on the processed plate blank, including: wiping a surface of the processed plate blank in step S4 with ethanol solution to obtain a wiped plate blank, and placing the wiped plate blank in a vacuum heat treatment furnace to perform vacuum heat treatment to obtain a heat-treated plate blank; and
S6, processing the heat-treated plate blank, including: machining the heat-treated plate blank in step S5 with a CNC machining center to obtain the Nb55Ti plate with the mass fraction of Nb of 44% to 46%, the mass fraction of Ti of 54% to 56%, Vickers Hardness (HV) greater than or equal to 150, and a recrystallization rate of 100%.

In an embodiment, in step S1, the blooming forging comprises: performing two cycles of axial upsetting and drawing-out on the heated ingot, followed by shaping to obtain the slab blank; an upsetting deformation amount is (0.6 to 0.7)×L millimeters (mm); a thickness H1 of the slab blank is (0.25 to 0.35)×Φ mm.

In an embodiment, in step S3, a method of the rolling comprises: rolling the machined slab blank along a direction of a width B1 of the slab blank until a thickness of the machined slab blank is H2 to obtain a rolled slab blank, rotating the rolled slab blank by 90°, and rolling the rolled slab blank along a length direction of the rolled slab blank until a thickness of the rolled slab blank is H3.

In an embodiment, H2 is (0.3 to 0.4)×H1 mm, and an upper limit of a thickness tolerance for a product with a thickness of H3 is +(0.2 to 0.25) mm.

In an embodiment, in step S4, the acid solution is prepared by uniformly mixing a hydrofluoric acid solution with a mass concentration of 30%, a nitric acid solution with a mass concentration of 70%, and water in a volume ratio of 3:1:1.

In an embodiment, in step S5, a method of the vacuum heat treatment includes: starting heating up when a vacuum degree inside the vacuum heat treatment furnace is in a range of 3×10⁻³ Pascals (Pa) to 2.5×10−3 Pa; a process of the heating up includes: heating up to 490° C. to 510° C. within 60 min and first holding for 30 min; after the first holding is completed, heating up to 770° C. to 800° C., with a permissible variation of plus or minus 5° C., within 30 min and second holding for 90 min; after the second holding is completed, cooling the vacuum heat treatment furnace to a temperature below 100° C. and removing the heat-treated plate blank from the vacuum heat treatment furnace.

In an embodiment, in step S6, before machining, before the machining, the heat-treated plate blank is covered with a film for protection.

In an embodiment, a Nb55Ti plate for a superconducting radio-frequency cavity is prepared by the preparation method for a Nb55Ti plate for a superconducting radio-frequency cavity.

In summary, the disclosure has the following beneficial effects compared to the related art.

1. The disclosure sequentially forges and rolls a Nb55Ti alloy blank, which effectively breaks and refines initial microstructure of the Nb55Ti alloy blank. By controlling total deformation degree and processing direction during each processing process, uniformity of transverse and longitudinal microstructure and properties of a Nb55Ti alloy plate product is significantly improved. Combined with vacuum heat treatment of the product, recrystallization degree, grain size, and transverse and longitudinal grain difference of the Nb55Ti alloy plate are effectively controlled, uniformity of grain size in the Nb55Ti alloy plate is improved, and contents of carbon (C), hydrogen (H), oxygen (O), and nitrogen (N) gas elements in the plates are effectively controlled, so that the Nb55Ti alloy plate is suitable for superconducting radio-frequency cavities.

2. The disclosure effectively removes surface contaminants introduced during processing processes of the Nb55Ti alloy plate by surface processing of the blank after each forging and rolling process, so that a surface of the Nb55Ti alloy plate is uniformly consistent, and the surface roughness complies with a specification, where an average roughness value Ra is smaller than or equal to 1.6 μm.

3. The differences in mechanical properties and hardness between a direction perpendicular to the rolling direction and the rolling direction of the Nb55Ti alloy plate prepared by the disclosure do not exceed 5%, the recrystallization rate of the plates is 100%, and grain size difference between the direction perpendicular to the rolling direction and the rolling direction are smaller than or equal to American Society of Testing Materials (ASTM) Grade 0.5 (ASTM E112-13), thereby ensuring that contents of gas elements, mechanical properties, hardness, grain size, and recrystallization rate of the plate all meet requirements for applications of 1.3 GHz 9-cell superconducting radio-frequency cavities.

### BRIEF DESCRIPTION OF DRAWINGS

The accompanying drawings described herein are used to provide a further understanding of the disclosure and form a part of the disclosure. The illustrated embodiments of the disclosure and description thereof are used to explain the disclosure and do not constitute undue limitation of the disclosure.

FIG. 1 illustrates a transverse (a direction perpendicular to a rolling direction) microstructure metallographic diagram of a δ 3 mm Nb55Ti alloy plate prepared in an embodiment 1 of the disclosure.

FIG. 2 illustrates a longitudinal (the rolling direction) microstructure metallographic diagram of the δ 3 mm Nb55Ti alloy plate prepared in the embodiment 1 of the disclosure.

FIG. 3 illustrates a transverse (the direction perpendicular to the rolling direction) microstructure metallographic diagram of a δ 6 mm Nb55Ti alloy plate prepared in an embodiment 2 of the disclosure.

FIG. 4 illustrates a longitudinal (the rolling direction) microstructure metallographic diagram of the δ 6 mm Nb55Ti alloy plate prepared in the embodiment 2 of the disclosure.

### DETAILED DESCRIPTION OF EMBODIMENTS

It should be noted that the embodiments and features in the embodiments of the disclosure can be combined with each other without conflict. The disclosure will be described in detail below with reference to the accompanying drawings and in conjunction with the embodiments.

It should be noted that the terms used here are only for describing specific embodiments and are not restricted to the illustrated embodiments according to the disclosure. As used herein, unless explicitly stated otherwise in the context, singular form may also encompass plural form. Moreover, it should be understood that when terms “including” and/or “comprising” are used in the disclosure, the terms indicate presence of features, steps, operations, devices, components, and/or combinations thereof.

Unless specifically stated otherwise, relative arrangements of components and steps, numerical expressions, and values described in the embodiments do not limit the scope of the disclosure. Moreover, it should be understood that for the sake of description, dimensions of various parts shown in the drawings are not drawn according to actual proportional relationships. For technologies, methods, and equipment well-known to those skilled in the art, detailed discussions may be omitted, but in appropriate cases, technologies, methods, and equipment should be considered as a part of the authorized disclosure. In all the examples shown and discussed herein, any specific value should be interpreted as merely illustrative and not restrictive. Thus, other examples of the illustrated embodiments may have different values. It should be noted that similar labels and letters in the drawings represent similar items. Therefore, once an item is defined in one figure, it need not be further discussed in subsequent figures.

The disclosure provides a preparation method for a Nb55Ti plate for a superconducting radio-frequency cavity, including the following steps S1-S6.

S1, forging: a niobium-titanium alloy ingot with a size of Φ×L, a mass fraction of Nb of 44% to 46%, and a mass fraction of Ti of 54% to 56% is heated to a temperature of 850° C. to 900° C., followed by holding the niobium-titanium alloy ingot at 850° C. to 900° C. for (0.5 to 0.6)×Φ min to obtain a heated ingot. Blooming forging is performed on the heated ingot to obtain a slab blank with a size of H1×B1×L1. Specifically, Φ represents a diameter of the niobium-titanium alloy ingot in mm, L represents a length of the niobium-titanium alloy ingot in mm, B1 represents a width of the slab blank in mm, H1 represents a thickness of the slab blank in mm, and L1 represents a length of the slab blank in mm.

S2, processing of a surface of the slab blank: the slab blank obtained from step S1 is machined with a CNC milling machine to remove surface defects of the slab blank to obtain a machined slab blank. After the machining, it is required to ensure that the surface of the slab blank is smooth and uniformly consistent, without any grinding marks or visible defects such as pits, cracks, fissures and inclusions.

S3, rolling: the machined slab blank in step S2 is rolled to obtain a plate blank with a size of H3×B2×L2. During the rolling, it is required to ensure that a heating temperature is in a range of 800° C. to 850° C., and a heating holding time is (0.8 to 1)×H1 min. Specifically, H3 represents a thickness of the plate blank in mm, B2 represents a width of the plate blank in mm, and L2 represents a length of the plate blank in mm.

S4, processing of a surface of the plate blank: the plate blank obtained from step S3 is sanded with a sander to obtain a sanded plate blank until the sanded plate blank is in a thickness tolerance range for a product. The sanded plate blank is placed in an acid solution to perform acid pickling for 3 min to 5 min, followed by rinsing with clean water and natural air drying to obtain a processed plate blank. After the processing of step S4, it is required to ensure that the surface of the processed plate blank is smooth and uniformly consistent, without any grinding marks or visible defects such as pits, cracks, fissures, and inclusions. That is to say, it is required to ensure that a surface roughness Ra of the processed plate blank is smaller than or equal to 1.6 μm.

S5, heat treatment of the processed plate blank: a surface of the processed plate blank in step S4 is wiped with ethanol solution to obtain a wiped plate blank. The wiped plate blank is placed in a vacuum heat treatment furnace to perform vacuum heat treatment to obtain a heat-treated plate blank.

S6, processing of the heat-treated plate blank: the heat-treated plate blank in step S5 is machined with a CNC machining center to make the Nb55Ti plate in a length and width tolerance range, thereby obtaining the Nb55Ti plate with the mass fraction of Nb of 44% to 46%, the mass fraction of Ti of 54% to 56%, HV greater than or equal to 150, and a recrystallization rate of 100%.

By a rational design of processing procedures and limits of process parameters, and combined with a vacuum heat treatment and surface processing, the method effectively breaks and refines initial microstructure of a Nb55Ti blank, significantly improves uniformity of grain size, uniformity of transverse and longitudinal structure, and properties of the Nb55Ti plate, and enhances hardness of the Nb55Ti plate, which is suitable for superconducting radio-frequency cavities. Moreover, the method increases processing yield of the Nb55Ti plate, reduces raw material costs, and enables stable mass production.

In an embodiment of the disclosure, in step S1, in order to make the forging process faster, the blooming forging is conducted by performing two cycles of axial upsetting and drawing-out, followed by shaping to obtain the slab blank. An upsetting deformation amount is (0.6 to 0.7)×L mm. After the shaping, a thickness H1 of the slab blank is (0.25 to 0.35)×Φ mm to facilitate subsequent processing. In this embodiment, only the thickness H1 needs to be considered during forging, while B1 and L1 will be processed by subsequent steps. The method of this embodiment can significantly improve preparation speed of the Nb55Ti plate.

In an embodiment of the disclosure, in step S3, the rolling is conducted by rolling the machined slab blank along a direction of a width B1 of the slab blank until a thickness of the machined slab blank is H2 to obtain a rolled slab blank, rotating the rolled slab blank by 90°, and rolling the rolled slab blank along a length direction of the rolled slab blank until a thickness of the rolled slab blank is H3. Specifically, H2 is (0.3 to 0.4)×H1 mm, and an upper limit of a thickness tolerance for a product with a thickness of H3 is +(0.2 to 0.25) mm. The method of gradually meeting size requirements of the plate blank by rolling along the direction of the width B1 to the thickness H2, rotating by 90°, and rolling along the length direction to the thickness H3, can make internal structure of the plate blank uniformly consistent, with isotropic in mechanical properties. The plate blank obtained can achieve differences in mechanical properties and hardness of no more than 5% between transverse and longitudinal, and grain size differences between transverse and longitudinal are smaller than or equal to ASTM Grade 0.5.

In an embodiment of the disclosure, in step S4, the acid solution employed is prepared by uniformly mixing a hydrofluoric acid solution with a mass concentration of 30%, a nitric acid solution with a mass concentration of 70%, and water in a volume ratio of 3:1:1. After practical use, it has been found that the acid solution mixed with the ratio can ensure that the surface of the processed plate blank after acid washing is smooth, metallic in color, and uniformly consistent, without any traces of acid solution.

In an embodiment of the disclosure, in step S5, a process of the vacuum heat treatment includes: when a vacuum degree inside the vacuum heat treatment furnace is in a range of 2.5×10−3 Pa to 3×10⁻³ Pa, heating up to 500° C.±10° C. (i.e., 490° C. to 510° C.) within 60 min and first holding for 30 min; heating up to 770° C. to 800° C., with a permissible variation of plus or minus 5° C., within 30 min and second holding for 90 min; cooling the vacuum heat treatment furnace to a temperature below 100° C. and removing the heat-treated plate blank from the vacuum heat treatment furnace.

In an embodiment of the disclosure, in step S6, before the machining, the heat-treated plate blank is covered with a film for protection. The covered plate blank, due to addition of a thin and transparent plastic film on the surface, can be protected from surface scratches and other defects during machining process, while the film also provides protection against water, dirt, wear, chemical corrosion, etc.

In addition, the disclosure provides a Nb55Ti plate for a superconducting radio-frequency cavity, which is prepared by the above method.

The embodiments of preparing a Nb55Ti plate by the above method is as follows.

### Embodiment 1

This embodiment includes the following steps.

Step 1, forging: a Nb55Ti blank with a size (diameter×length) of @180× 300 mm is heated at 850° C. for 90 min to obtain a heated blank. Two cycles of upsetting and drawing-out with sizes of @180×300→Φ284×120→Φ142×300→Φ284×120→Φ142×300 are performed on the heated blank, followed by shaping along an axial direction (i.e., 300 mm direction) to obtain a Nb55Ti slab blank with a size (thickness×width×length) of δ45×300×565 mm.

Step 2, processing of a surface of the slab blank: the Nb55Ti slab blank with a size (thickness×width×length) of δ45×300×565 mm in step 1 is machined and milled along a 565 mm direction to obtain a machined Nb55Ti slab blank with a size (thickness×width×length) of δ40.3₀⁺³ mm×295.3₀⁺³ mm×560.3₀⁺³ mm.

Step 3, rolling: the machined Nb55Ti slab blank with a size (thickness×width×length) of δ40.3₀⁺³ mm×295.3₀⁺³ mm×560.3₀⁺³ mm in step 2 is heated at 800° C. for 35 min to obtain a heated Nb55Ti slab blank. The heated Nb55Ti slab blank is rolled along a 295 mm direction until a thickness of the heated Nb55Ti slab blank is a thickness of δ12 mm to obtain a rolled Nb55Ti slab blank. The rolled Nb55Ti slab blank is rotated by 90°, and rolled along a 560 mm direction until a thickness of the rolled Nb55Ti slab blank is a thickness of δ3.04₀^{+0.2} mm to obtain a plate blank with a size (thickness×width×length) of δ3.0₀^{+0.2} mm×983 mm×2240 mm.

Step 4, processing of a surface of the plate blank: the plate blank obtained from step S3 is sanded with a sander to obtain a sanded plate blank until the sanded plate blank is in a thickness tolerance range for a product. During the sanding, both two sides of the plate blank are sanded to a thickness of 3.0₀^{+0.1} mm by employing a sander with a 400 #sanding belt. The sanded plate blank is placed in an acid solution to perform acid pickling for 3 min, followed by rinsing with clean water and natural air drying to obtain a processed plate blank. A size (thickness×width×length) of the processed plate blank obtained after surface processing is δ3.0_{-0.1}^{+0.1} mm×983 mm×2240 mm.

Step 5, heat treatment of the processed plate blank: a surface of the processed plate blank processed in step S4 is wiped with ethanol solution to obtain a wiped plate blank. The wiped plate blank is placed in a vacuum heat treatment furnace to perform vacuum heat treatment to obtain a heat-treated plate blank. A process of the vacuum heat treatment includes: when a vacuum degree inside the vacuum heat treatment furnace does not exceed 3×10⁻³ Pa, heating up to 500° C.±10° C. (i.e., 490° C. to 510° C.) within 60 min and first holding for 30 min; heating up to 770° C.±5° C. (i.e., 765° C. to 775° C.) within 30 min and second holding for 90 min; cooling the vacuum heat treatment furnace to a temperature below 100° C. and removing the heat-treated plate blank from the vacuum heat treatment furnace.

Step 6, processing of the heat-treated plate blank: the heat-treated plate blank in step S5 is machined with a CNC machining center to obtain the Nb55Ti plate until the Nb55Ti plate is in a length and width tolerance range for a product. Before the machining, equipment of the CNC machining center is cleaned and the heat-treated plate blank is covered with a film for protection. Finally, 8 Nb55Ti plates with a size (diameter×thickness) of Φ480₀⁺²×δ3.0_{-0.1}⁺⁰¹ mm, the mass fraction of Nb of 44% to 46%, the mass fraction of Ti of 54% to 56%, HV greater than or equal to 150, and a recrystallization rate of 100% are obtained.

The acid solution employed in step S4 of this embodiment is prepared by uniformly mixing a hydrofluoric acid solution with a mass concentration of 30%, a nitric acid solution with a mass concentration of 70%, and water in a volume ratio of 3:1:1. The surface of the processed plate blank after acid washing in step S4 is smooth, metallic in color, and uniformly consistent, without any traces of acid solution. Moreover, the surface of the machined slab blank machined in step 2 and the surface of the sanded plate blank sanded in step 4 are smooth and uniformly consistent, without any grinding marks or visible defects such as pits, cracks, fissures, inclusions, etc.

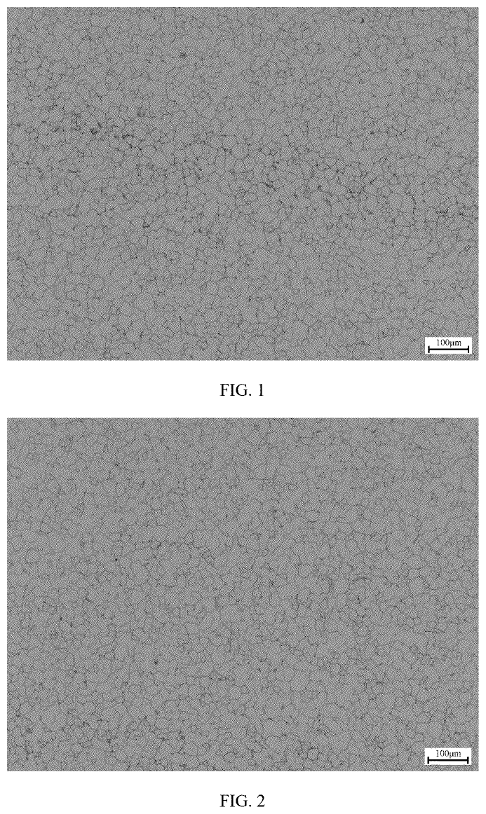

FIG. 1 is a transverse (a direction perpendicular to a rolling direction) microstructure metallographic diagram of a 83 mm high-purity niobium plate prepared in the embodiment 1 of the disclosure. It can be seen from FIG. 1 that all grains in the microstructure are 100% recrystallized, and the grains are equiaxed with uniform size, with a main grain size being ASTM Grade 8 (0.022 mm).

FIG. 2 is a longitudinal (the rolling direction) microstructure metallographic diagram of the 83 mm high-purity niobium plate prepared in the embodiment 1 of the disclosure. It can be seen from FIG. 2 that all grains in the microstructure are 100% recrystallized, and the grains are equiaxed with uniform size, with a main grain size being ASTM Grade 8 (0.022 mm).

Performance and composition of the Nb55Ti plate prepared in this embodiment were tested, and test results are shown in Table 1.

TABLE 1
Composition of the Nb55Ti plate obtained in embodiment 1

| Gas elements | C/w/% | N/w/% | H/w/% | O/w/% |
|---|---|---|---|---|
| Actual measured | 0.008 | 0.001 | 0.0008 | 0.031 |
| value | | | | |

| | Mechanical properties/hardness | | | |
|---|---|---|---|---|
| | tensile | yield | | |
| | strength/ | strength/ | elongation/ | hardness/ |
| | MPa | MPa | % | Hv |
| Transverse (vertical | 493 | 446 | 15.5 | 171 |
| rolling direction) | | | | |
| Longitudinal | 489 | 439 | 16.0 | 169 |
| (rolling direction) | | | | |
| Horizontal and | 0.81% | 1.58% | 3.17% | 1.18% |
| vertical difference | | | | |

| | Grain size/recrystallization rate | |
|---|---|---|
| | Grain size (ASTM) | Recrystallization rate/% |
| Transverse the direction | 8 | 100 |
| perpendicular to the | | |
| (rolling direction) | | |
| Longitudinal (rolling | 8 | 100 |
| direction) | | |

| Surface roughness | Ra/μm |
|---|---|
| Transverse (the direction | 1.1 |
| perpendicular to the | |
| rolling direction) | |
| Longitudinal (rolling | 1.0 |
| direction) | |

The surface of the Nb55Ti plate prepared in this embodiment is uniformly consistent, and contents of gas elements, mechanical properties, hardness, grain size, and recrystallization rate thereof all meet requirements for applications of superconducting radio-frequency cavities.

### Embodiment 2

This embodiment includes the following steps.

Step 1, forging: a Nb55Ti blank with a size (diameter×length) of Φ220×400 mm is heated at 900° C. for 130 min to obtain a heated blank. Two cycles of upsetting and drawing-out with sizes of Φ220×400→Φ400×120→Φ195×400→Φ400×120→Φ195×400 are performed on the heated blank, followed by shaping along an axial direction (i.e., 400 mm direction) to obtain a Nb55Ti slab blank with a size (thickness×width×length) of δ77×400×493 mm.

Step 2, processing of a surface of the slab blank: the Nb55Ti slab blank with a size (thickness×width×length) of δ77×400×493 mm in step 1 is machined and milled along a 493 mm direction to obtain a machined Nb55Ti slab blank with a size (thickness×width×length) of δ70₀⁺³ mm×395.3₀⁺³ mm×485₀⁺³ mm.

Step 3, rolling: the machined Nb55Ti slab blank with a size (thickness×width×length) of δ70₀⁺³ mm×395₀⁺³ mm×485₀⁺³ mm in step 2 is heated at 850° C. for 70 min to obtain a heated Nb55Ti slab blank. The heated Nb55Ti slab blank is rolled along a 395 mm direction until a thickness of the heated Nb55Ti slab blank is a thickness of 831 mm to obtain a rolled Nb55Ti slab blank. The rolled Nb55Ti slab blank is rotated by 90°, and rolled along a 485 mm direction until a thickness of the rolled Nb55Ti slab blank is a thickness of δ6.0₀^{+0.2} mm to obtain a plate blank with a size (thickness×width×length) of 86.2 mm×980 mm×2505 mm.

Step 4, processing of a surface of the plate blank: the plate blank obtained from step S3 is sanded with a sander to obtain a sanded plate blank until the sanded plate blank is in a thickness tolerance range for a product. During the sanding, both two sides of the plate blank are sanded to a thickness of 6.0 mm by employing a sander with a 400 #sanding belt. The sanded plate blank is placed in an acid solution to perform acid pickling for 5 min, followed by rinsing with clean water and natural air drying to obtain a processed plate blank. A size (thickness×width×length) of the processed plate blank obtained after surface treatment is δ6.0_{-0.1}^{+0.1} mm×980 mm×2505 mm.

Step 5, heat treatment of the processed plate blank: a surface of the processed plate blank processed in step S4 is wiped with ethanol solution to obtain a wiped plate blank. The wiped plate blank is placed in a vacuum heat treatment furnace to perform vacuum heat treatment to obtain a heat-treated plate blank. A process of the vacuum heat treatment includes: when a vacuum degree inside the vacuum heat treatment furnace does not exceed 3×10⁻³ Pa, firstly, heating up to 500° C.±10° C. (i.e., 490° C. to 510° C.) within 60 min and holding for 30 min; heating up to 800° C.±5° C. (i.e., 795° C. to 805° C.) within 30 min and second holding for 90 min; cooling the vacuum heat treatment furnace to a temperature below 100° C. and removing the heat-treated plate blank from the vacuum heat treatment furnace.

Step 6, processing of heat-treated plate blank: the heat-treated plate blank in step S5 is machined with a CNC machining center to obtain the Nb55Ti plate until the Nb55Ti plate is in a length and width tolerance range for a product. Before the machining, equipment of the CNC machining center is cleaned and the heat-treated plate blank is covered with a film for protection. Finally, 10 Nb55Ti plates with a size (diameter×thickness) of Φ450₀⁺²×δ6.0_{-0.1}^{+0.1} mm, the mass fraction of Nb of 44% to 46%, the mass fraction of Ti of 54% to 56%, HV greater than or equal to 150, and a recrystallization rate of 100% are obtained.

The acid solution employed in step S4 of this embodiment is prepared by uniformly mixing a hydrofluoric acid solution with a mass concentration of 30%, a nitric acid solution with a mass concentration of 70%, and water in a volume ratio of 3:1:1. The surface of the processed plate blank after acid washing in step S4 is smooth, metallic in color, and uniformly consistent after acid washing, without any traces of acid solution. Moreover, the surface of the machined slab blank machined in step 2 and the surface of the sanded plate blank sanded in step 4 are smooth and uniformly consistent, without any grinding marks or visible defects such as pits, cracks, fissures, inclusions, etc.

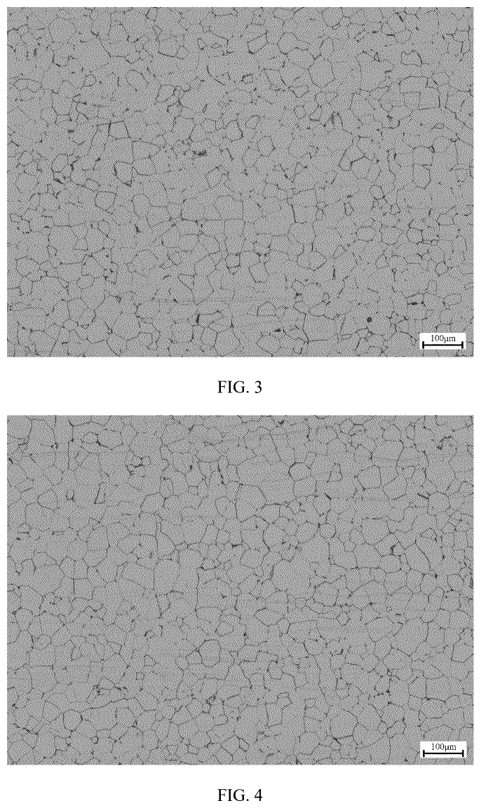

FIG. 3 is a transverse (a direction perpendicular to a rolling direction) microstructure metallographic diagram of a 86 mm high-purity niobium plate prepared in the embodiment 2 of the disclosure. It can be seen from FIG. 3 that all grains in the microstructure are 100% recrystallized, and the grains are equiaxed with uniform size, with a main grain size being ASTM Grade 7 (0.032 mm).

FIG. 4 is a longitudinal (the rolling direction) microstructure metallographic diagram of the 86 mm high-purity niobium plate prepared in the embodiment 2 of the disclosure. It can be seen from FIG. 4 that all grains in the microstructure are 100% recrystallized, and the grains are equiaxed with uniform size, with a main grain size being ASTM Grade 7 (0.032 mm).

Performance and composition of the Nb55Ti plate prepared in this embodiment were tested, and test results are shown in Table 2.

TABLE 2
Composition of the Nb55Ti plate obtained in embodiment 2

| Gas elements | C/w/% | N/w/% | H/w/% | O/w/% |
|---|---|---|---|---|
| Actual measured | 0.01 | <0.003 | 0.0008 | 0.029 |
| value | | | | |

| | Mechanical properties/hardness | | | |
|---|---|---|---|---|
| | tensile | yield | | |
| | strength/ | strength/ | elongation/ | hardness/ |
| | MPa | MPa | % | Hv |
| Transverse (vertical | 539 | 517 | 18.5 | 170 |
| rolling direction) | | | | |
| Longitudinal (rolling | 540 | 509 | 19.0 | 174 |
| direction) | | | | |
| Horizontal and | 0.19% | 1.56% | 2.67% | 2.33% |
| vertical difference | | | | |

| | Grain size/recrystallization rate | |
|---|---|---|
| | Grain size (ASTM) | Recrystallization rate/% |
| Transverse (the direction | 7 | 100 |
| perpendicular to the | | |
| rolling direction) | | |
| Longitudinal (rolling | 7 | 100 |
| direction) | | |

| Surface roughness | Ra/μm |
|---|---|
| Transverse (the direction | 1.15 |
| perpendicular to the | |
| rolling direction) | |
| Longitudinal | 1.1 |
| (rolling direction) | |

The surface of the Nb55Ti plate prepared in this embodiment is uniformly consistent, and contents of gas elements, mechanical properties, hardness, grain size, and recrystallization rate thereof all meet requirements for applications of superconducting radio-frequency cavities.

The above are only illustrated embodiments of the disclosure and are not limited to the disclosure. For those skilled in the related art, the disclosure may have various modifications and variations. Any modifications, equivalent substitutions, improvements, etc. made within the spirit and principles of the disclosure should be included in the scope of protection of the disclosure.

What is claimed is:

1. A preparation method for a Nb55Ti plate for a superconducting radio-frequency cavity, comprising:
S1, forging, comprising: heating a niobium-titanium alloy ingot with a size of Φ×L, a mass fraction of niobium (Nb) of 44% to 46%, and a mass fraction of titanium (Ti) of 54% to 56% to a temperature of 850 Celsius degrees (° C.) to 900° C., followed by holding the niobium-titanium alloy ingot at 850° C. to 900° C. for (0.5 to 0.6)×Φ minutes (min) to obtain a heated ingot; performing blooming forging on the heated ingot to obtain a slab blank with a size of H1×B1×L1; wherein the blooming forging comprises: performing two cycles of axial upsetting and drawing-out on the heated ingot, followed by shaping to obtain the slab blank; an upsetting deformation amount is (0.6 to 0.7)×L millimeters (mm); a thickness H1 of the slab blank is (0.25 to 0.35)×Φ mm; Φ represents a diameter of the niobium-titanium alloy ingot in mm, L represents a length of the niobium-titanium alloy ingot in mm, B1 represents a width of the slab blank in mm, H1 represents a thickness of the slab blank in mm, and L1 represents a length of the slab blank in mm;
S2, processing a surface of the slab blank, comprising: machining the slab blank obtained from step S1 with a computer numerical control (CNC) milling machine to remove surface defects of the slab blank to obtain a machined slab blank;
S3, rolling, comprising: rolling the machined slab blank in step S2 to obtain a plate blank with a size of H2×B2× L2; wherein, during the rolling, a heating temperature is in a range of 800° C. to 850° C., and a heating holding time is (0.8 to 1)× H1 min; a method of the rolling comprises: rolling the machined slab blank along a direction of a width B1 of the slab blank until a thickness of the machined slab blank is H2 to obtain a rolled slab blank, rotating the rolled slab blank by 90°, and rolling the rolled slab blank along a length direction of the rolled slab blank until a thickness of the rolled slab blank is H3; and H2 represents a thickness of the plate blank in mm, B2 represents a width of the plate blank in mm, and L2 represents a length of the plate blank in mm;
S4, processing a surface of the plate blank, comprising: sanding the plate blank obtained from step S3 with a sander to obtain a sanded plate blank, placing the sanded plate blank in an acid solution to perform acid pickling for 3 min to 5 min, followed by rinsing with clean water and natural air drying to obtain a processed plate blank, to ensure that a surface roughness Ra of the processed plate blank is smaller than or equal to 1.6 microns (μm);
S5, performing heat treatment on the processed plate blank, comprising: wiping a surface of the processed plate blank in step S4 with ethanol solution to obtain a wiped plate blank, and placing the wiped plate blank in a vacuum heat treatment furnace to perform vacuum heat treatment to obtain a heat-treated plate blank; and
S6, processing the heat-treated plate blank, comprising: machining the heat-treated plate blank in step S5 with a CNC machining center to obtain the Nb55Ti plate with the mass fraction of Nb of 44% to 46%, the mass fraction of Ti of 54% to 56%, Vickers Hardness (HV) greater than or equal to 150, and a recrystallization rate of 100%.

2. The preparation method for the Nb55Ti plate for the superconducting radio-frequency cavity as claimed in claim 1, wherein H2 is (0.3 to 0.4)×H1 mm, and an upper limit of a thickness tolerance for a product with a thickness of H3 is +(0.2 to 0.25) mm.

3. The preparation method for the Nb55Ti plate for the superconducting radio-frequency cavity as claimed in claim 1, wherein in step S4, the acid solution is prepared by uniformly mixing a hydrofluoric acid solution with a mass concentration of 30%, a nitric acid solution with a mass concentration of 70%, and water in a volume ratio of 3:1:1.

4. The preparation method for the Nb55Ti plate for the superconducting radio-frequency cavity as claimed in claim 1, wherein in step S5, a method of the vacuum heat treatment comprises: starting heating up when a vacuum degree inside the vacuum heat treatment furnace is in a range of 3×10⁻³ Pascals (Pa) to 2.5×10⁻³ Pa; a process of the heating up comprises: heating up to 490° C. to 510° C. within 60 min and first holding for 30 min; after the first holding is completed, heating up to 770° C. to 800° C., with a permissible variation of plus or minus 5° C., within 30 min and second holding for 90 min; after the second holding is completed, cooling the vacuum heat treatment furnace to a temperature below 100° C. and removing the heat-treated plate blank from the vacuum heat treatment furnace.

5. The preparation method for the Nb55Ti plate for the superconducting radio-frequency cavity as claimed in claim 1, wherein in step S6, before the machining, the heat-treated plate blank is covered with a film for protection.

6. A Nb55Ti plate for a superconducting radio-frequency cavity, prepared by the preparation method for the Nb55Ti plate for the superconducting radio-frequency cavity as claimed in claim 1.
